(19) United States
(12) Patent Application Publication
(10) Pub. No.: US 2006/0202431 A1
(43) Pub. Date: Sep. 14, 2006

(54) Memory seal assembly for an internal combustion engine

(76) Inventor: Bryan S. Breen, Commerce Township, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/079,758

(22) Filed: Mar. 14, 2005

(51) Int. Cl. F02F 11/00

(52) U.S. Cl. 277/592

(57) ABSTRACT

A seal assembly that includes a first mating component, a second mating component, and a gasket having a predetermined shape that is positioned between the first and second mating components and subjected to compression load. The gasket is constructed out of a memory material, such as a nickel titanium alloy. Upon application of heat from a heat source, gasket is urged to the original predetermined shape from the compressed configuration, thereby applying a desired force against the first and second mating components.

### TECHNICAL FIELD

The present invention relates generally to sealing assemblies, and more particularly to a sealing assembly having a resilient body for sealing components of internal combustion engines, wherein the sealing assembly is capable of returning to its original shape.

### BACKGROUND

The use of gaskets in internal combustion engines to seal mating surfaces therein is commonly known. For example, gaskets are typically used to seal the interface between the cylinder head and the engine block, as well as between the cylinder head and the exhaust manifold. These gaskets help to prevent the escape of gases and liquids that circulate throughout the engine and to maintain adequate levels of compression during engine operation. However, although gaskets have been proven to be effective in preventing the escape of gases and liquids, they have several disadvantages.

One disadvantage of conventional gaskets includes their vulnerability to structural damage that frequently occurs during shipping, installation or handling of the gasket. For example, during installation, the gasket is subject to varying levels of compression that frequently cause damage to the gasket, which leads to premature gasket failure. As a result of that damage, the gasket is less effective in preventing the escape of gases and liquids from the engine. This results in decreased efficiency in engine performance and increased emission of gases that are harmful to the environment.

A second disadvantage of conventional gaskets arises from non-uniform loading across the gasket surface when installed. Accordingly, those areas having relatively reduced loading are a source of premature gasket failure. Therefore, as stated above, gases and liquids that circulate within the engine are allowed to escape.

In view of the foregoing disadvantages, designers have developed several improved gaskets. In particular, designers have developed a spring-energized gasket that includes a superalloy. When such a gasket is installed within the engine (e.g., between the cylinder head and engine block) the spring properties of the gasket enable it to expand within the engine block, thereby forming a seal between the cylinder head and engine block while the engine is in operation.

A second example of an improved gasket is an expandable graphite gasket, which includes unexpanded or un-exfoliated graphite flakes. Upon heating, the un-exfoliated graphite flakes separate and expand to several times their original thickness, causing the gasket to expand and fill in gaps and imperfections in the surfaces to be sealed by the gasket.

Although these improved gaskets have been proven to be effective, they also have disadvantages. One such disadvantage is their inability to maintain an adequate seal in the event the gaskets are damaged during shipping, installation or handling. For example, although the spring-energized and expandable graphite gaskets are capable of expanding to create an improved seal, they are incapable of maintaining such a seal in the event of gasket damage. Consequently, even these so-called improved gaskets are subjected to premature failure when damaged or deformed. Further, automotive gaskets, for example, are subject to extreme variations in temperature. The foregoing spring-energized and graphite gaskets have a tendency to be affected by these extreme variations, which also leads to insufficient gasket performance.

The embodiments described below were developed in light of these and other disadvantages of the existing gaskets.

### SUMMARY

A seal assembly for use with an internal combustion engine is disclosed. The seal assembly includes a first mating component, a second mating component, and a gasket having a predetermined shape that is positioned between the first and second mating components. When positioned between the first and second components, the gasket is subjected to a compression load. The gasket is constructed out of a memory material, such as a nickel titanium alloy. Upon application of heat from a heat source, gasket is urged to the original predetermined shape from the compressed configuration, thereby applying a desired force against the first and second mating components. The heat source may be the heat from an operating combustion engine, or application of heat from an electrical current.

In one embodiment, the gasket is a wound exhaust manifold gasket. In another embodiment, the gasket is a cylinder head gasket having at least one layer.

### BRIEF DESCRIPTION OF THE DRAWINGS

These and other features and advantages of the invention will be apparent from the following detailed description and the appended claims, taken in conjunction with the accompanying drawings, in which:

FIG. 1 is an exploded perspective view of a cylinder head assembly having a head gasket according to an embodiment of the present invention;

FIG. 2 is a cross-sectional view of a cylinder head assembly having the head gasket of FIG. 1 and an exhaust manifold gasket disposed between the cylinder head and the exhaust manifold according to an embodiment of the present invention.

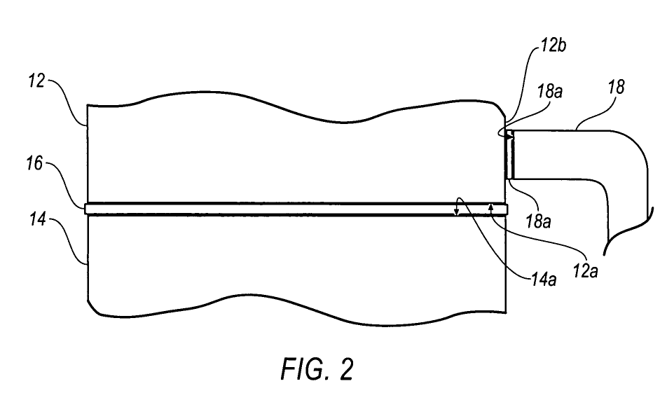

### DETAILED DESCRIPTION

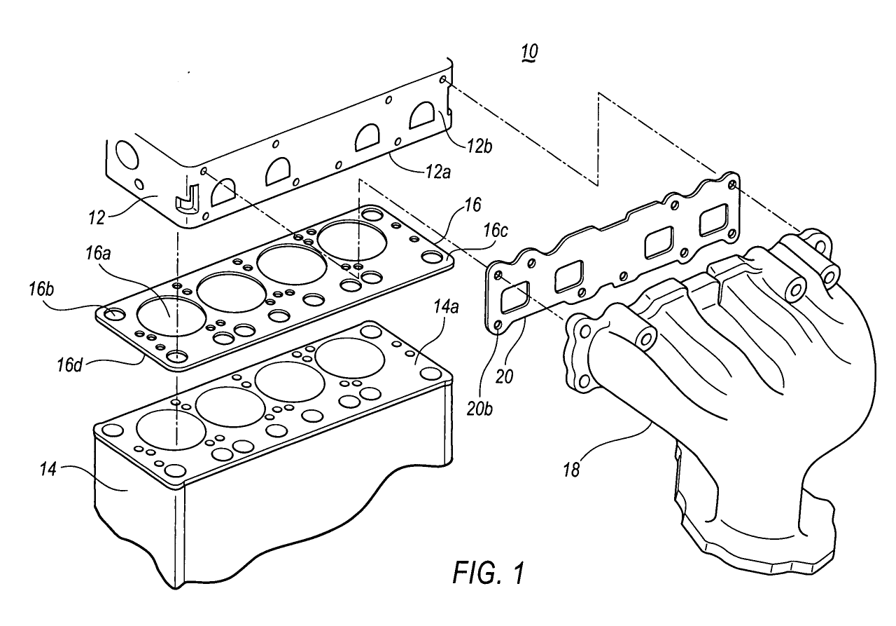

The embodiments described herein provide an improved sealing assembly for assuring that appropriate sealing exists within an engine in a manner that is both efficient with respect to manufacturing as well as in a manner designed to avoid premature failure of cylinder head and exhaust manifold gaskets. Referring initially to FIG. 1, a cylinder head assembly 10 is shown. Cylinder head assembly 10 includes a cylinder head 12, an engine block 14 and an exhaust manifold 18. Disposed between cylinder head 12 and engine block 14 is a head gasket 16. Head gasket 16 prevents the escape of gases and liquids from cylinder head assembly 10 and enables the proper compression of gases within cylinder head assembly 10 during engine operation.

Cylinder head 12 includes a cylinder head mating surface 12a that mates with a first surface 16c of head gasket 16. Engine block 14 has an engine block mating surface 14a. Engine block mating surface 14a mates with a second surface 16d of head gasket 16.

Exhaust manifold 18 is connected to cylinder head 12 at cylinder head mating surface 12b. The connection between exhaust manifold 18 and cylinder head 12 is sealed by an exhaust manifold gasket 20. Exhaust manifold gasket 20 prevents exhaust leakage out of the connection and ensures that all exhaust gas will properly flow through a catalytic converter (not shown) for treatment.

In one embodiment, head gasket 16 is a multilayer gasket comprising several layers. Additionally, exhaust manifold gasket 20 may be a wound exhaust manifold gasket. As shown, gaskets 16 and 20 are formed with multiple apertures. In particular, and as shown in FIG. 1, head gasket 16 includes at least one bolt hole aperture 16b and several cylinder bore apertures 16a. Exhaust manifold gasket 20 similarly includes at least on bolt hole aperture 20 that aligns with bolt holes formed on exhaust manifold 18. Gaskets 16 and 20 also include multiple un-numbered apertures for coolant and bypass gases, as will be appreciated by those skilled in the art.

In accordance with one aspect of the invention, gaskets 16 and 20 are comprised of a nickel titanium steel alloy material such as Nitinol. These materials are given a memory shape upon formation through methods known to those familiar with the art. Once given a memory shape, if this material is subsequently deformed, the application of sufficient heat from a heat source such as an operating engine or an electric current will cause the material to return to its original memory shape or configuration. Accordingly, even in the event that gaskets 16 and 20 become damaged or deformed during shipping, installation or handling, the application of naturally created heat from the engine or heat generated by an electric current from a current source will cause gaskets 16 and 20 to return to their original design shape or configuration. Accordingly, gaskets 16 and 20 are capable of consistently applying a desired spring force to the mating sealing surfaces in the engine.

As noted above, gaskets 16 and 20 may be attached to an electrical current source (not shown) so that application of the electric current causes the gaskets 16 and 20 to be heated and return to the memory shape. The electric current may come from wires associated with imbedded sensors (not shown), a direct connection with a battery (not shown), or from any other source appropriate for the application.

To manufacture a gasket in accordance with the present invention, first, a suitable memory material is provided, such as nickel titanium alloy. The material is then formed into a predetermined and desired shape. For example, head gasket 16 may be provided with embossments (not shown) around cylinder bores 16a.

When installed, a gasket 16, 20 made in accordance with the present invention, will function as in a typical fashion to seal around the openings formed in the mating surfaces. That is, the seal is compressed between the mating surfaces. However, because the memory material, and in particular, nickel titanium alloy, reacts to heat, when heat is applied to the gasket 16, 20, the gasket will be automatically urged to return to is original design and shape, while consistently applying the desired spring force to the mating sealing surfaces. Thus, when the components are assembled prior to shipping and if the gasket 16, 20 becomes deformed in some manner, a predetermined amount of heat will automatically return the gasket 16, 20 to its original predetermined shape.

In one embodiment, the gasket 16, 20 must be heated to approximately 900° C. (1652° F.) to return the gasket 16, 20 to its original shape. Naturally created heat, such as the heat from an operating combustion engine, or the application of an electrical current may be used to apply sufficient heat to cause the gasket 16, 20 to return to its original memory shape or design.

As described in the above, the embodiments set forth herein are capable of maintaining an improved seal between various mating surfaces of an internal combustion engine. Furthermore, even in the event of gasket shape deformation or gasket damage, gaskets 16 and 20 are capable of maintaining a tight seal between mating surfaces by consistently applying a sufficient force to the mating surfaces of the internal combustion engine in response to the application of heat or current.

Various other modifications to the present invention may occur to those skilled in the art to which the present invention pertains. Other modifications not explicitly mentioned herein are also possible and within the scope of the present invention. For example, the foregoing description refers to gaskets for internal combustion engines. However, as will be recognized by one of ordinary skill in the art, the present invention may be utilized in any high pressure, high temperature environment requiring a tight seal. It is the following claims, including all equivalents, which define the scope of the present invention.

What is claimed is:

1. A seal assembly for an internal combustion engine comprising:
a first mating component having a first plurality of apertures formed therein;
a second mating component having a second plurality of apertures formed therein, said second plurality of apertures aligning with corresponding to said first plurality of apertures;
a gasket member having a predetermined shape and further including a third plurality of apertures that correspond to said first and second plurality of apertures, said gasket member being constructed of a nickel titanium steel alloy;
wherein said gasket member is disposed between said first mating component and said second mating component such that said first, second and third plurality of apertures are aligned with one another, and wherein said gasket member is subjected to a compression load, whereby said seal is deformed from its original predetermined shape; and
wherein said gasket member is urged to return to its said original predetermined shape and apply a force against said first and second mating components when subjected to heat from a heat source.

2. An assembly according to claim 1, wherein said gasket is a wound exhaust manifold gasket.

3. An assembly according to claim 1, wherein said gasket is a cylinder head gasket.

4. An assembly according to claim 3, wherein said gasket includes a plurality of layers.

5. An assembly according to claim 1, wherein said first mating component is a cylinder head of an internal combustion engine.

6. An assembly according to claim 6, wherein said second mating component is an engine block.

7. An assembly according to claim 6, wherein said second mating component is an exhaust manifold.

8. An assembly according to claim 1, wherein said heat source is an operating internal combustion engine.

9. An assembly according to claim 1, wherein said heat source is an electric current.

10. An assembly according to claim 1, wherein said heat source generates heat that is at least about 900° C. (1652° F.).

11. An assembly according to claim 1, wherein said original predetermined shape includes embossments formed at least one surface of said nickel titanium alloy gasket.
